(19) United States
(12) Patent Application Publication
(10) Pub. No.: US 2026/0078837 A1
(43) Pub. Date: Mar. 19, 2026

(54) ROBUST ELECTROHYDRAULIC PRESSURE CONTROL WITH DISTRIBUTED DAMPING

(71) Applicant: Sunstream Scientific, Inc., Chicago, IL (US)

(72) Inventor: Michael Kenneth Kriegsmann, Chicago, IL (US)

(21) Appl. No.: 19/329,956

(22) Filed: Sep. 16, 2025

Related U.S. Application Data
(60) Provisional application No. 63/695,023, filed on Sep. 16, 2024.

(51) Int. Cl. F16K 31/40; F15B 13/044; F16K 11/07

(52) U.S. Cl. CPC F16K 31/406; F16K 11/07; F15B 13/044

(57) ABSTRACT

Disclosed herein are methods and systems of robust electrohydraulic pressure control with distributed damping. The system includes a two-stage pilot operated electrohydraulic pressure reducing-relieving valve have a valve body with a high-pressure port, a low-pressure port, and a variable working pressure port. A valve spool is disposed within the valve body to direct oil flow into and out of a working volume, and a pilot subsystem is also disposed within the valve body to generate a pilot pressure and create a hydraulic motive force to operate the valve spool. A linear electromagnetic actuator is operatively coupled to the pilot subsystem to generate an electromotive force to operate the pilot assembly.

### CROSS REFERENCE TO RELATED APPLICATIONS

This application claims the benefit of U.S. Provisional Application No. 63/695,023, filed on Sep. 16, 2024, and entitled “ROBUST ELECTROHYDRAULIC PRESSURE CONTROL with DISTRIBUTED DAMPING,” which is hereby incorporated by reference herein in its entirety.

### REFERENCE REGARDING FEDERALLY SPONSORED RESEARCH OR DEVELOPMENT

Not applicable

### BACKGROUND OF THE DISCLOSURE

### 1. Field of the Disclosure

The present disclosure relates to fluid power pressure control valves, and more specifically to electrohydraulic pilot operated pressure reducing/relieving valves that incorporate linear electro-magnetic actuators as a means to convert electrical current to mechanical force.

### 2. Description of the Background of the Disclosure

In many fluid power systems, it is desirable to produce work by controlling oil pressure in a cavity of variable volume, or to counterbalance loads, or regulate flow, or any number of functions. Electrohydraulic pressure-reducing relieving valves are the leading economical technology for these purposes, and commercially available from a broad number of suppliers in a broad selection of sizes and configurations. However, these valves are dynamically complex with poorly understood behavior and prone to poor dynamic response.

It is a primary objective of the present invention to provide an economical solution which is fast and demonstrates robust dynamic stability and may be deployed in a cartridge type valve body.

### 3. Description of Related Art

U.S. Pat. No. 5,062,454 discloses an electrohydraulic pressure control valve with an energizing spring operatively disposed between a solenoid armature and pilot. However, the prior application does not teach a method to individually tune the damping of the armature, pilot, and main spool.

U.S. Publication No. 2023/0366418, filed by the present inventor, discloses an electrohydraulic pressure control valve with a spring energized pilot poppet, and methods to individually tune the solenoid armature, pilot, and spool. However, the prior application does not teach methods to arrange these components within a compact cartridge-type valve body as disclosed in the present application.

### SUMMARY OF THE DISCLOSURE

The invention can be generally categorized as a two stage pilot operated, electrohydraulic pressure reducing-relieving (also pressure control) valve comprising a valve body with a high pressure (supply) port, a low pressure (drain) port, a variable pressure work port, and an alternative high pressure pilot supply port; a valve spool disposed within a cartridge type valve body to direct oil flow into and out of a working volume; a pilot subsystem also disposed within the valve body to generate a pilot pressure creating a hydraulic motive (hydramotive) force to operate the valve spool; and a linear electromagnetic actuator operatively coupled to the pilot subsystem to generate an electromotive force to operate the pilot assembly. Operationally, the pilot assembly amplifies the electromotive force to create a hydramotive force that is significantly higher in magnitude.

It is an object of the present invention to provide a fluid power valve which is fast, robust in dynamic stability, reliable, and robust in construction.

It is another object of the invention to demonstrate a means to individually tune the damping characteristics of each dynamic element including, but not limited to, the valve spool, the pilot assembly, and the armature—the armature being the working component of the electromagnetic actuator immediately coupled to the pilot assembly. In pursuit of this objective, a common high-pressure fluid is employed in the dynamic control of the fluid power elements—delivering clean hydraulic fluid to a network of dashpots and the control port of the pilot assembly. It is desirable to utilize high pressure fluid for damping, as the stiffness of hydraulic fluid increases with increasing pressure due to the entrained air common to hydraulic systems. In further pursuit of this objective, a novel architecture is demonstrated that balances all dynamic elements regardless of the magnitude of the high- and low-pressure hydraulic fluid. This architecture is further advantageous in that it reduces the operational envelope of the pilot subsystem thus improving dynamic robustness.

It is a further object of the present invention to disclose a strategy to attenuate force and motion disturbances on the armature assembly cause by operation of the 2^{nd} stage (main) valve spool. In pursuit of this objective, operative coupling between the armature and the pilot subsystem is achieved not through a rigid transfer rod, but through a compliant spring.

### BRIEF DESCRIPTION OF THE DRAWINGS

FIG. 1 is a cross-sectional view of a linear solenoid energized electrohydraulic pressure control valve comprising pressure biased spool and pilot stages and distributed damping.

FIG. 2 is a cross-sectional view of a linear solenoid energized and pressure biased pilot valve comprising a conical metering element and illustrating individually tunable damping volumes. The solenoid is shown in an energized condition.

FIG. 3 is a flat spring with multiple features to locate a poppet.

FIG. 4 is the electrohydraulic pressure control valve of FIG. 1 illustrated in the fully de-energized condition.

FIG. 5 is the electrohydraulic pressure control valve of FIG. 1 illustrated in an energized condition with the valve spool partially biased.

### DETAILED DESCRIPTION OF THE DRAWINGS

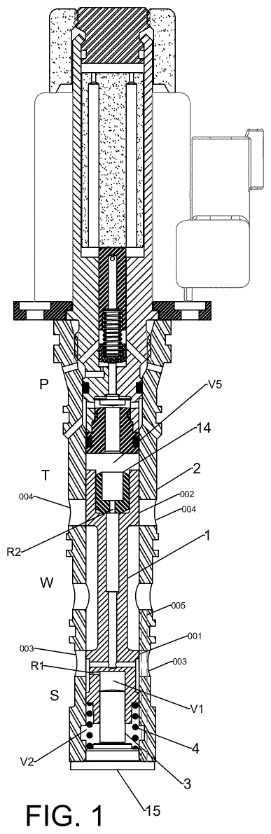

FIG. 1 illustrates an electrohydraulic pressure control valve assembly, in which the working flow of pressurized hydraulic fluid through the valve is directed by a valve spool 1, disposed within a cartridge type valve body 2, and energized by a hydraulic motive force generated by an electrohydraulic pilot valve. The electrohydraulic pilot valve comprises two coupled subsystems including a linear electromagnetic actuator and a pilot valve subsystem.

The cartridge type valve body 2, into which the valve spool 1 is received and slidably disposed, is defined in part by a cylindrical bore configured to receive said valve spool, a plurality of coaxial inner and external cylindrical features and comprises high pressure supply port S, high pressure damping port P, wherein ports P and S share a common external pressure source, low pressure tank port T, and working pressure port W.

The valve spool 1 comprises cylindrical lands 001 and 002, which act cooperatively as a bearing surface for guiding axial movement. The valve body 2 further comprises a plurality of circumferentially arranged windows in groups 003 and 004 that provide fluid transmission paths between port S and port W, and port W and port T respectively, and regulated by displacement of lands 001 and 002.

A spool bias pin 3 is received by a cylindrical cavity in spool 1 and configured to isolate a variable, cylindrical bias volume V1 from a spool feedback volume V2. Oil is communicated between bias volume V1 and supply port S via restriction R1, formed within valve spool 1.

Spool 1 includes a reduced-diameter shoulder feature to receive one end of a valve spring 4, deployed within feedback volume V2 and encircling bias pin 3, wherein said valve spring is configured to ensure a reliable return of the valve spool when the electric coil is de-energized. Working oil pressure in port W is communicated to feedback volume V2 by means of an oil transmission path 005 formed within valve body 2 as shown with hidden lines in FIG. 1. End plug 15 is received by the bore and a counterbore feature of valve body 2 and rigidly disposed, wherein the end plug isolates oil pressure in V2 from supply pressure S and wherein end plug 15 includes features configured to receive the opposite end of valve spring 4 and to seat bias pin 3.

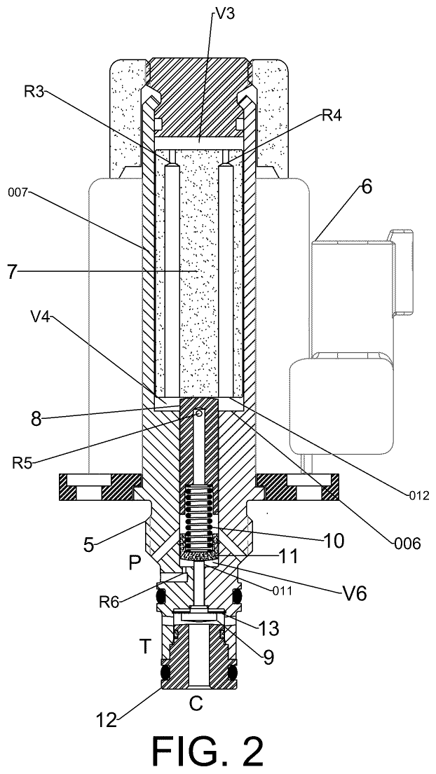

Refer to FIG. 2 for detailed illustrations of the pilot subsystem comprising an electric coil 6, armature 7, stator pole feature 006, and stator tube feature 007 that collectively define a functional linear solenoid stator integrated with a pilot body 5 and sharing a common axis, wherein the armature is received within a cylindrical cavity of stator tube 007 and slidably disposed, and wherein the stator tube is received within the ID of the coil assembly and rigidly disposed. Coil assembly 6, armature 7, stator pole feature 006, and stator tube feature 007 cooperatively define a magnetic circuit including a variable air gap and are configured to generate a working electromotive force when the coil is energized. Oil is communicated between damping volume V3 and damping volume V4 via restrictions R3 and R4, formed within armature 7, and configured to dampen motion of said armature.

This subsystem further comprises push piston 8, pilot poppet 9, energizing spring 10, and pilot piston 11, all received within a common bore of pilot body 5 and movably disposed, and a pilot seat 12 also received separately within pilot body 5 and rigidly disposed. Armature 7 and pilot poppet 9 are operatively coupled by a mechanical chain comprising push piston 8, energizing spring 10, and pilot piston 11. Push piston 8 includes a coaxial counterbore feature to receive one end of the energizing spring 10. Pilot piston 11 includes a coaxial counterbore feature to receive the opposite end of said energizing spring. Oil is communicated between volume V4 and pilot port P via restriction R5, formed within push piston 8, and in series with an oil transmission path through features formed in valve body 2 and pilot body 5.

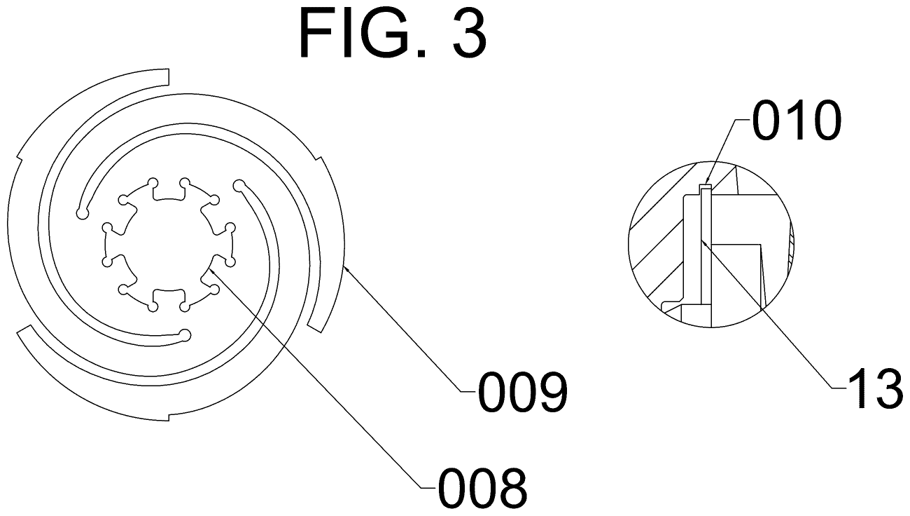

FIG. 3 illustrates details of flexure spring 13. Pilot poppet 9 is coupled to flat flexure spring 13 by a polar array of features 008, arranged around the innermost perimeter of the flexure spring, which are configured to engage and secure to the stem of pilot poppet 9. A second array of features 009, arranged around the outermost perimeter of flexure spring 13, are configured to engage a receiving groove 010 formed within an opposed cylindrical cavity of pilot body 5. The flexure spring aligns the conical surface of poppet 9 with pilot seat 12 while permitting free axial play of the poppet.

Pilot body 5 includes a plurality of pilot ports providing flow paths for low pressure fluid T, high pressure pilot fluid P, and variable control pressure C, wherein pressure C is associated with control volume V5. A plurality of o-ring seals disposed along pilot cage 5 prevent leakage of pressurized fluid between the ports. Volume V5 receives pressurized oil from supply port S via restriction R2, formed within plug 14 that is received by valve spool 1 and rigidly disposed, as illustrated in FIG. 1.

In the de-energized state, the oil egress path from control volume V5, through pilot seat 12 and past pilot poppet 9 to pilot port T is substantially less restrictive than the oil ingress path from port S through restriction R2 into said control volume. Consequently, control pressure C is substantially closer to low pressure T than to high pressure supply S. By energizing coil 6, a magnetic field is generated that attracts armature pole feature 012 to the stator pole feature 006. As armature 7 moves toward stator pole feature 006, it engages push piston 8, wherein displacement of said push piston compresses the energizing spring and transfers electromotive force to pilot poppet 9 through a mechanical chain including pilot piston 11 and poppet stem feature 011. The force thus imparted on pilot poppet 9 causes the poppet to move in the direction of pilot seat 12, and the oil egress path from the control volume C to tank port T to be more restrictive. The control pressure C thus reaches a new equilibrium pressure increased toward supply S.

When the pilot system is in equilibrium, the electromotive force transferred mechanically to the pilot poppet via energizing spring 10 is described as:

$${F}_{emf} = {k}_{spring} ( Δ {x}_{armature} - Δ {x}_{pilot \cdot piston} )$$

The components are configured in a manner wherein the operational travel of armature 7 is substantially greater than the operational travel of pilot poppet 9. The mechanical force transferred to the pilot piston can thus be estimated as:

$${F}_{spring} \approx Δ {x}_{armature} {k}_{spring}$$

Oil pressure in volume V6 acting upon the cross-sectional area of poppet stem 011 generates a hydramotive force that cooperates with said electromotive force to generate pilot poppet 9 motion in the direction of pilot seat 12.

The pilot poppet reaches equilibrium when the control pressure C working against the area of the poppet seat 12 is balanced by the control force imparted upon the poppet by the pilot piston 11.

$${P}_{control} {Area}_{poppet seat} = {F}_{emf} + {P}_{supply} {Area}_{stem}$$

Movement of armature 7 in the direction of stator pole feature 006, causes armature volume V3 to expand, while stator volume V4 is caused to contract. Restrictions R3 and R4 permit restrictive oil flow from volume V4 to volume V3. And restriction R5 permits restrictive oil from volume V4 to port P. In this manner, restrictions R3, R4, and R5 are configured to dampen the motion of armature 7. Movement of pilot piston 11 in the direction away from the armature causes volume V6 to be contracted, wherein restriction R6 permits restrictive oil flow from volume V6 to port P and is configured to dampen motion of said pilot piston.

FIG. 1 illustrates an energized operational state wherein valve spool 2 is partially shifted to a neutral flow condition. Land 002 restricts oil flow between working port W and low-pressure port T, and land 001 restricts oil flow between working port W and high-pressure port P. Working pressure W is defined by a function comprising high pressure P and low-pressure T and coefficients K_{IN}, defined by the transmissibility of oil between port W and port T, and K_{OUT} defined by the transmissibility of oil between port W and port P.

$$W = \frac{{K}_{IN}^{2} P + {K}_{OUT}^{2} T}{{K}_{IN}^{2} + {K}_{OUT}^{2}}$$

When K_{IN}=K_{OUT}, pressure W=0.5*(P+T). However, when the working volume W is static, small deviations in valve spool position from neutral result in large changes in the ratio between K_{IN} and K_{OUT} and thus correspondingly large changes in working pressure W.

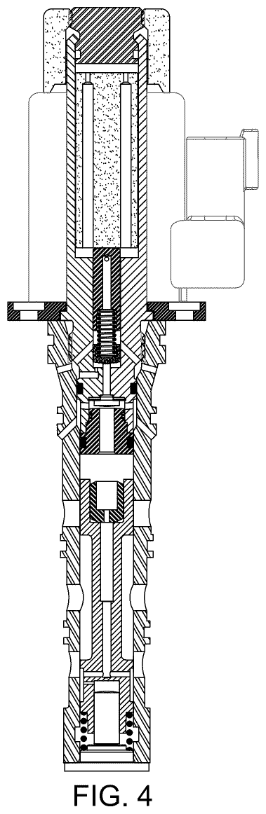

FIG. 4 illustrates an energized operational state wherein valve spool 1 is shifted to its full displacement high flow condition. Land 002 closes the oil flow windows 004 between low pressure tank port T and working pressure port W, and land 001 uncovers windows 003 to permit unrestricted oil flow from high pressure port S to working pressure port W.

Movement of valve spool 1 in the direction away from the pilot valve causes spool bias volume V1 to be contracted, wherein the oil in said contracting volume is forced through restriction R1 to supply port S so that spool motion is accommodated. This throttling effect generates a backpressure that dampens the motion of valve spool 1.

Said motion of valve spool 1 further causes an expansion of control oil volume V5. As volume V5 expands with positive spool motion, pilot poppet 9 must adjust accordingly and shift further toward poppet seat 012 in order to maintain the desired control pressure setting. This arrangement of the pilot valve subsystem is conceived to maintain pilot control pressure C when pilot control volume V5 rapidly changes as valve spool 1 translates linearly. Armature 7 is substantially heavier than the collective mass of pilot poppet 9 and pilot piston 11 moving in unison, and the maximum travel of armature 7 is substantially greater than the maximum travel of poppet 9. Consequently, the electromotive force transferred by energizing spring 10 from armature 7 to pilot poppet 9 is configured to be nearly constant in the presence of poppet motion perturbations.

Valve spool 1 reaches equilibrium when control pressure C working against the control area of valve spool 1 is balanced by the working pressure W in V2 imparted upon the feedback area of valve spool 1, the pressure force in V1 imparted against the bias area of the valve spool, and the force exerted by valve spring 4 as it compresses in response to spool translation. Note that in the static operating condition, fluid pressure in spool bias volume V1 is equal to high pressure supply S. Ignoring the valve spring force which can be mitigated with proper calibration:

$${P}_{control} {Area}_{valveC} = {P}_{working} {Area}_{feedback} + {P}_{supply} {Area}_{bias}$$

If the following design relations are employed:

$$\frac{{Area}_{control}}{{Area}_{bias}} = \frac{{Area}_{poppet}}{{Area}_{pin}}$$

All terms for P_{supply} cancel, and working pressure can be estimated by the following equation:

$${P}_{working} = \frac{{Area}_{control}}{( {Area}_{poppet seat} ) ( {Area}_{feedback} )} {F}_{emf}$$

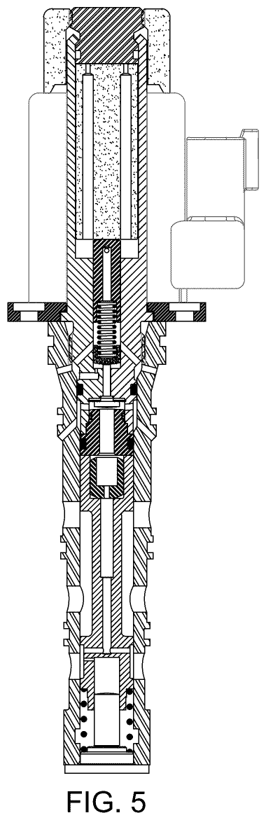

FIG. 5 illustrates a de-energized operational state wherein land 001 of valve spool 1 isolates high pressure port P from working port W, and land 002 permits communication of fluid from working port W to tank port T. The return spring 4 biases the valve in the direction of the pilot assembly until a hard stop engagement with pilot body 5.

The embodiments disclosed herein are similar to U.S. 2023/0366418, which is hereby incorporated by reference in its entirety.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use aspects of the disclosure. The exclusive rights to all modifications which come within the scope of the appended claims are reserved.

I claim:

1. A hydraulic valve comprising:
a valve body including:
a first port for receiving fluid from a first high-pressure source;
a second port to drain the fluid to a low-pressure reservoir;
a third, working port, wherein a fluid pressure is variable during normal valve operation; and
a fourth port for receiving fluid from a second high-pressure source
a pilot assembly at least partially disposed within the valve body and defining a first volume in fluid communication with the first port, the pilot assembly including:
an electromechanical actuator that converts an electrical signal into mechanical force and motion and comprises an armature;
a first fluid metering element; and;
an energizing spring, wherein said spring is arranged so as to transfer the mechanical force produced by said electromechanical actuator to said first fluid metering element via an energizing spring force; and
a second fluid metering element, substantially larger than said first fluid metering element, received into said valve body and moveably disposed, the second fluid metering element at least partially defining a control volume and a second volume, the control volume disposed between the first fluid metering element and the second fluid metering element, the second volume disposed opposite the control volume, the second volume in fluid communication with the fourth port,
wherein, said first fluid metering element defines a variable fluid path from the control volume to the second port,
wherein, a first end of the energizing spring is operatively coupled to the armature, and an opposing end of said spring is operatively coupled to said first fluid metering element;
wherein a first surface of the first fluid metering element receives a first pressure force opposing said energizing spring force from fluid within the control volume,
wherein a second surface, operatively coupled to said first fluid metering element, receives a second pressure force assisting said energizing spring force from fluid within the first volume,
wherein a third surface of the second fluid metering element receives a third pressure force from fluid within the control volume,
wherein a fourth surface receives a fourth pressure force opposing the third pressure force from fluid within the second volume, and
wherein a fifth surface receives a working pressure force opposing the third pressure force from fluid within the third port.

2. The hydraulic valve of claim 1 further comprising a pilot piston, wherein said pilot piston receives one end of said energizing spring, and
wherein said pilot piston is operatively coupled to said first fluid metering element.

3. The hydraulic valve of claim 2 further comprising a first fluid path that restrictively communicates fluid from the first port to said first volume,
wherein said first volume is defined in part by a position of said pilot piston, and
wherein motion of said pilot piston induces a pressure differential across said first fluid path to create a damping effect.

4. The hydraulic valve of claim 2 further comprising a second fluid path that is configured to restrictively communicate fluid from the first port to the first volume,
wherein the first volume is defined in part by a position of said first fluid metering element, and
wherein motion of said first fluid metering element induces a pressure differential across said second fluid path to create a damping effect.

5. The hydraulic valve of claim 3, wherein said first volume is additionally defined in part by a position of said first fluid metering element, and
wherein motion of said first fluid metering element further induces a pressure differential across the first fluid path.

6. The hydraulic valve of claim 3 further comprising a push piston, wherein said push piston receives one end of said energizing spring, and
wherein said push piston is operatively coupled to said armature.

7. The hydraulic valve of claim 6 further comprising a third fluid path through said push piston, configured to restrictively communicate fluid from said first port to a third volume of fluid defined in part by the position of the armature,
wherein linear motion of said armature induces a pressure differential across said third fluid path to create a damping effect.

8. The hydraulic valve of claim 7 further comprising a fourth fluid path through said armature, configured to restrictively communicate fluid from said third volume to a fourth volume of fluid defined in part by the position of the armature element,
wherein linear motion of said armature induces a pressure differential across said fourth fluid path to create a damping effect.

9. The hydraulic valve of claim 1, further comprising a fifth fluid path, configured to restrictively communicate fluid from said fourth port to the second volume,
wherein the second volume is defined in part by a position of said second fluid metering element, and
wherein motion of said second fluid metering element induces a pressure differential across the fifth fluid path to create a damping effect.

10. The hydraulic valve of claim 9, wherein said fourth surface partially defines said second volume.

11. The hydraulic valve of claim 1, wherein surface areas of said first, second, third, and fourth surfaces are related by:
$$\frac{{Area}_{surface 3}}{{Area}_{surface 4}} = \frac{{Area}_{surface 1}}{{Area}_{surface 2}}$$

12. The hydraulic valve of claim 1, wherein said first fluid metering element is a poppet.

13. The hydraulic valve of claim 12, further comprising a poppet seat, wherein said poppet seat receives said poppet, and
wherein a frustum formed at an interface between said poppet and said poppet seat defines said first surface.

14. The hydraulic valve of claim 13 further comprising a flat pilot spring, wherein said flat pilot spring is arranged such that it suspends said poppet at a fixed distance from said poppet seat when the valve is in a de-energized state.

15. The hydraulic valve of claim 14 further comprising a stem, wherein said stem is operatively coupled to said poppet, and
wherein said second surface is a feature of said stem, said second surface being orthogonal to an axis of said stem.

16. The hydraulic valve of claim 1 further comprising a pilot valve body with a bore, wherein said pilot valve body is received by said valve body and rigidly disposed, and
wherein said pilot valve body receives said first fluid metering element and a pilot piston.

17. The hydraulic valve of claim 16, wherein said pilot valve body further receives said energizing spring and a push piston.

18. The hydraulic valve of claim 17, wherein said pilot valve body includes a plurality of apertures to provide for fluid flow, wherein said pilot valve body further includes a plurality of pilot ports, and
wherein a plurality of seals disposed along an outer surface of said pilot valve body prevent leakage of fluid between the pilot ports.

19. The hydraulic valve of claim 18, wherein said second fluid metering element is a spool, wherein said spool includes a plurality of lands, said lands cooperatively defining a bearing surface for axial movement.
